(19) United States
(12) Patent Application Publication
(10) Pub. No.: US 2008/0137561 A1
(43) Pub. Date: Jun. 12, 2008

(54) RF REPEATER USED FOR TIME DIVISION DUPLEXING AND METHOD THEREOF

(75) Inventors: Seong-Min KIM, Daejeon (KR); Byung-Su KANG, Daejeon (KR); Yun-soo KO, Daejeon (KR); Heon-Kook KWON, Daejeon (KR); Kwang-Chun LEE, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 11/951,480

(22) Filed: Dec. 6, 2007

(30) Foreign Application Priority Data
Dec. 6, 2006 (KR) 10-2006-0123025
Jun. 14, 2007 (KR) 10-2007-0058186

(51) Int. Cl. H04B 7/14

(52) U.S. Cl. 370/279

(57) ABSTRACT

The present invention relates to an RF repeater used in a time division method, and a method thereof. An RF repeater according to an exemplary embodiment of the present invention receives a downlink signal that is to be transmitted from a base station to a mobile terminal, performs first automatic gain control on the downlink signal, and extracts gain information from the downlink signal on which the first automatic gain control has been performed, on the basis of gain variation information that is the gain information for the downlink signal. Then, the RF repeater performs second automatic gain control on the downlink signal on the basis of the extracted gain information, and performs a control operation such that the downlink signal on which the second automatic gain control has been performed is transmitted to the mobile terminal. According to the exemplary embodiment of the present invention, the RF repeater maintains the received uplink signal at the predetermined level or more by using a pilot signal of a subcarrier that is not allocated during the downlink period, regardless of the number of mobile terminals that are connected to the RF repeater. As a result, the RF repeater can efficiently perform automatic gain control on the uplink signal without performing separate signal analysis or control.

### CROSS-REFERENCE TO RELATED APPLICATION

This application claims priority to and the benefit of Korean Patent Application No. 10-2006-0123025 filed in the Korean Intellectual Property Office on Dec. 06, 2006, and No. 10-2007-0058186 filed in the Korean Intellectual Property Office on Jun. 14, 2007, the entire contents of which are incorporated herein by reference.

### BACKGROUND OF THE INVENTION

(a) Field of the Invention

The present invention relates to an RF (radio frequency) repeater used for time division duplexing and a method thereof. More particularly, the present invention relates to an RF repeater based on orthogonal frequency division multiple access-time division duplex (OFDMA-TDD) that performs efficient automatic gain control during an uplink and a downlink and outputs a synchronization signal having high precision to a base station and a mobile terminal, and a method thereof.

This work was supported by the IT R&D program of MIC/IITA [2005-S-404-12, Research & Development of Radio Transmission Technology for 3G evolution].

(b) Description of the Related Art

A mobile communication system that uses OFDMA-TDD is composed of a network. The network includes terminals that transmit and receive user information, a plurality of base stations (or access points) that relay various signals after appropriately processing the signals, a repeater that removes an octave band region, a router that controls the plurality of base stations, and the like.

At this time, the base station and a radio frequency (hereinafter simply referred to as “RF”) repeater directly determine wireless coverage that corresponds to a service region. When a transmitting/receiving synchronization is mismatched between the base station and the RF repeater, various problems occur. For example, communication is not possible between the base station, the RF repeater, and the terminal within a given coverage.

According to a related art for solving these problems, the signal receiving intensity of the base station-is measured, the measured signal receiving intensity is compared with a predetermined threshold value, a transmission or reception state is determined according to the comparison result, and a transmission or reception state signal is generated. Also, it discloses a technology for generating transmission and reception clocks on the basis of the generated transmission or reception state signal, generating transmission and reception state frame signals, and effectively synchronizing transmission and reception timing between the base station and the RF repeater.

The RF repeater according to the related art generates a synchronization signal by only using a power signal that is received from a donor antenna. As a result, when a spurious signal is input to the donor antenna, an erroneous synchronization signal may be generated.

Further, when mobile terminals are connected through a remote antenna, a level difference occurs in received uplink signals according to the number of mobile terminals. As a result, the RF repeater according to the related art performs a separate analysis to perform automatic gain control on the uplink signals. Therefore, when the level difference is extreme, it may be difficult to accurately perform the automatic gain control. Furthermore, the RF repeater according to the related art needs a separate analyzing device that analyzes the uplink signals to perform the automatic gain control.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an RF repeater based on OFDMA-TDD (orthogonal frequency division multiple access-time division duplex) and a method thereof, having advantages of performing efficient automatic gain control on an uplink and a downlink and outputting an accurate synchronization signal to a base station and a mobile terminal.

An exemplary embodiment of the present invention provides an RF repeater that relays signal transmission and reception between a base station and a mobile terminal. The RF repeater includes: a control signal generator that performs first automatic gain control on a downlink signal received from the base station and generates automatic gain control information that corresponds to the first automatic gain control; a relay controller that extracts gain information corresponding to the automatic gain control information received from the control signal generator on the basis of gain variation information stored in advance, the gain variation information indicating the gain information on the automatic gain control information, and that generates a control signal on the basis of the extracted gain information; and a downlink RF unit that performs second automatic gain control on the downlink signal on the basis of the gain information, and performs a control operation such that the downlink signal on which the second automatic gain control has been performed is transmitted to the mobile terminal.

The RF repeater may further include an uplink RF unit that couples a pilot signal to an uplink signal received from the mobile terminal, performs third automatic gain control on a signal that is obtained by coupling the pilot signal and the uplink signal, removes the pilot signal from the signal on which the third automatic gain control has been performed, and transmits the signal to the base station.

The control signal generator may analyze the downlink signal to extract information of a subcarrier allocated to an uplink, generate a pilot signal of information of a subcarrier, which is not allocated, on the basis of the extracted information, and transmit the pilot signal to the uplink RF unit.

Another embodiment of the present invention provides an RF repeater that relays signal transmission and reception between a base station and a mobile terminal. The RF repeater includes a control signal generator that analyzes a downlink signal to extract information of a subcarrier allocated to an uplink, and generates a pilot signal of information of a subcarrier, which is not allocated, on the basis of the extracted information, and an uplink RF unit that couples a pilot signal to an uplink signal received from the mobile terminal, performs automatic gain control on a signal that is generated by coupling the uplink signal and the pilot signal, removes the pilot signal from the signal on which the automatic gain control has been performed, and transmits the signal to the base station.

The RF repeater may include a phase controller that receives the pilot signal from the control signal generator, controls a phase of the pilot signal, and generates a first signal to offset the pilot signal.

The uplink RF unit may receive the first signal from the phase controller and remove the pilot signal from the signal on which the automatic gain control has been performed.

Yet another embodiment of the present invention provides an RF repeating method in which an RF repeater relays signal transmission and reception between a base station and a mobile terminal. The method includes receiving a downlink signal that is to be transmitted from the base station to the mobile terminal, and performing first automatic gain control on the downlink signal, extracting gain information from the downlink signal on which the first automatic gain control has been performed, on the basis of gain variation information, the gain variation information indicating the gain information for the downlink signal, performing second automatic gain control on the downlink signal on the basis of the extracted gain information, and performing a control operation such that the downlink signal on which the second automatic gain control has been performed is transmitted to the mobile terminal.

The method may further include, before the performing of the first automatic gain control, extracting a synchronization signal between the base station and the mobile terminal on the basis of the downlink signal and compensating for a location compensation value of the RF repeater that is stored in advance in the synchronization signal, and generating a first synchronization signal to transmit/receive a signal between the base station and the mobile terminal.

According to an embodiment of the present invention, there is provided an RF repeating method in which an RF repeater relays signal transmission and reception between a base station and a mobile terminal. The method includes receiving an uplink signal from the mobile terminal, coupling a first pilot signal that is not allocated during a downlink period before receiving the uplink signal to the uplink signal, generating a second pilot signal to offset the first pilot signal, performing automatic gain control on the downlink signal to which the first pilot signal is coupled, and coupling the second pilot signal to the downlink signal to which the first pilot signal on which the automatic gain control has been performed is coupled.

In the generating of the second pilot signal, a phase of the first pilot signal may be converted to offset the first pilot signal.

### BRIEF DESCRIPTION OF THE DRAWINGS

FIG. 1 is a block diagram illustrating an RF repeater used in a time division method according to an exemplary embodiment of the present invention.

FIG. 2 is a block diagram specifically illustrating a control signal generator and an RF relay controller of an RF repeater according to an exemplary embodiment of the present invention.

FIG. 3 is a flowchart illustrating an RF repeating method of an RF repeater during a downlink period according to an exemplary embodiment of the present invention.

FIG. 4 is a flowchart illustrating an RF repeating method of an RF repeater during an uplink period according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “unit”, “module”, and “block” used herein mean one unit that processes a specific function or operation, and may be implemented by hardware or software and a combination thereof.

An RF repeater used for time division duplexing and a method thereof according to an exemplary embodiment of the present invention will be described in detail with reference to the accompanying drawings.

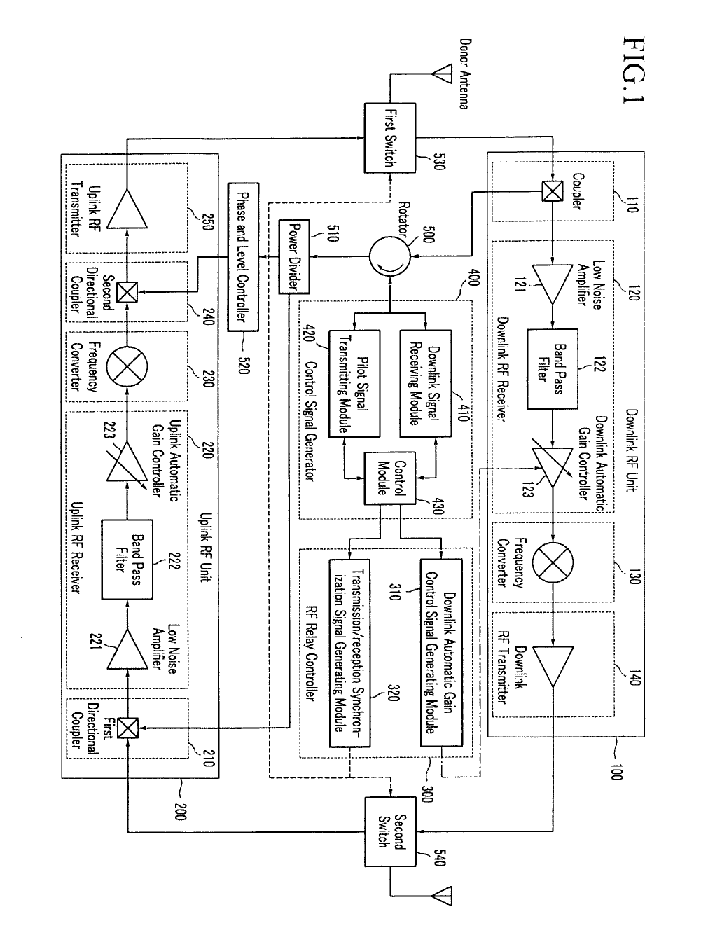

FIG. 1 is a block diagram illustrating an RF repeater used in a time division method according to an exemplary embodiment of the present invention.

As shown in FIG. 1, an RF repeater according to an exemplary embodiment of the present invention includes a downlink RF unit 100, an uplink RF unit 200, a control signal generator 400, an RF relay controller 300, a first switch 530, a second switch 540, a rotator 500, a power divider 510, and a phase and level controller 520.

The downlink RF unit 100 includes a coupler 110, a downlink RF receiver 120, a frequency converter 130, and a downlink RF transmitter 140.

The coupler 110 divides a downlink signal that is received from the first switch 530 into two power signals, and transmits the two power signals to the rotator 500 and a low noise amplifier 121 of the downlink RF receiver 120, respectively.

The downlink RF receiver 120 includes the low noise amplifier 121, a band pass filter 122, and a downlink automatic gain controller 123. The downlink RF receiver 120 selects a signal of a predetermined band from the downlink signals that have been received from the coupler 110, and performs gain control on the selected downlink signal.

The low noise amplifier 121 amplifies the downlink signal that has been received from the coupler 110 by a predetermined value and transmits it to the band pass filter 122.

The band pass filter 122 performs a filtering operation on the amplified signal received from the low noise amplifier 121 to extract a signal in a predetermined band. The band pass filter 122 transmits the filtered signal to the downlink automatic gain controller 123.

The downlink automatic gain controller 123 receives a downlink automatic gain control signal from a downlink automatic gain control signal generating module 310 of the RF relay controller 300. The downlink automatic gain controller 123 performs automatic gain control on the signal that has been filtered by the band pass filter 122, on the basis of the received automatic gain control signal.

The frequency converter 130 performs frequency conversion on the signal that has been received from the downlink automatic gain controller 123 of the downlink RF receiver 120, according to a predetermined format.

The downlink RF transmitter 140 increases the magnitude of the signal that has been received from the frequency converter 130 by a predetermined value so as to transmit the signal to a mobile terminal (not shown), and transmits the signal to the second switch 540.

The control signal generator 400 includes a downlink signal receiving module 410, a pilot signal transmitting module 420, and a control module 430.

The downlink signal receiving module 410 detects a synchronization signal of the base station (not shown) and the mobile terminal (not shown) during a current downlink period on the basis of the downlink signal received from the coupler 110. In addition, the downlink signal receiving module 410 performs automatic gain control on the downlink signal that has been received from the coupler 110, and generates an automatic gain performing signal that corresponds to the automatic gain control.

Further, the downlink signal receiving module 410 transmits the synchronization signal and the automatic gain performing signal to the control module 430.

Further, the downlink signal receiving module 410 analyzes a downlink signal during a downlink period, extracts subcarrier information allocated to an uplink during an uplink period, and transmits the extracted information to the control module 430.

Under control of the control module 430, the pilot signal transmitting module 420 generates a pilot signal of a subcarrier, which is not allocated during the downlink period before receiving the uplink signal, and transmits it to the power divider 510.

The control module 430 controls the downlink signal receiving module 410 and the pilot signal transmitting module 420. Further, the control module 430 generates automatic gain control information to perform automatic gain control of the downlink signal on the basis of the automatic gain performing signal that has been received from the downlink signal receiving module 410. Furthermore, the control module 430 transmits the generated automatic gain control information to the downlink automatic gain control signal generating module 310 of the RF relay controller 300.

The control module 430 transmits the synchronization signal that has been received from the downlink signal receiving module 410 to the RF relay controller 310.

The control module 430 receives subcarrier information, which is allocated to an uplink during a next uplink period, from the downlink signal receiving module 410. The control module 430 controls the pilot signal transmitting module 420 to generate a pilot signal of a subcarrier, which is not allocated during the next uplink period, on the basis of the received subcarrier information.

At this time, according to the exemplary embodiment of the present invention, the function of the control signal generator 400 may be performed by the mobile terminal, and thus may be replaced by the mobile terminal.

The RF relay controller 300 includes the downlink automatic gain control signal generating module 310 and a transmission/reception synchronization signal generating module 320.

The downlink automatic gain control signal generating module 310 maps the automatic gain control information, which has been received from the control module 430 of the control signal generator 400, with downlink gain variation information stored in advance, and extracts gain information. The downlink automatic gain control signal generating module 310 generates a downlink automatic gain control signal to perform gain control on the downlink signal on the basis of the extracted gain information.

Then, the downlink automatic gain control signal generating module 310 transmits the generated downlink automatic gain control signal to the downlink automatic gain controller 123 of the downlink RF unit 100.

The transmission/reception synchronization signal generating module 320 receives a synchronization signal from the control module 430 of the control signal generator 400. Then, the transmission/reception synchronization signal generating module 320 compensates for a path delay value according to a location of the RF repeater stored in advance in the received synchronization signal. The transmission/reception synchronization signal generating module 320 then generates a transmission/reception synchronization signal to transmit/receive the signal between the base station and the mobile terminal during the next uplink period.

Then, the transmission/reception synchronization signal generating module 320 transmits the generated transmission/reception synchronization signal to the first switch 530 and the second switch 540.

The rotator 500 separates the transmitting/receiving signal of the control signal generator 400.

The power divider 510 receives the pilot signal generated by the control signal generator 400 using the rotator 500. The power divider 510 divides the received pilot signal into two power signals and transmits them to a first directional coupler 210 of the uplink RF unit 200 and the phase and level controller 520, respectively.

The phase and level controller 520 controls the phase and level of the pilot signal that has been received from the power divider 510, and transmits the pilot signal to a second directional coupler 240. At this time, the phase and level controller 520 controls the phase of the pilot signal such that the generated pilot signal and the received pilot signal are offset. For example, the generated pilot signal and the received pilot signal have a phase difference of 180 degrees.

The uplink RF unit 200 includes a first directional coupler 210, an uplink RF receiver 220, a frequency converter 230, the second directional coupler 240, and an uplink RF transmitter 250.

The first directional coupler 210 couples the pilot signal received from the power divider 510 and the uplink signal received through the second switch 540, and transmits the coupled signal to the uplink RF receiver 220.

The uplink RF receiver 220 includes a low noise amplifier 221, a band pass filter 222, and an uplink automatic gain controller 223.

The low noise amplifier 221 amplifies the uplink signal received from the first directional coupler 210 by a predetermined value, and transmits the amplified signal to the band pass filter 222.

The band pass filter 222 performs a filtering operation on the amplified signal that has been received from the low noise amplifier 221 to extract a signal in a predetermined band, and transmits the filtered signal to the uplink automatic gain controller 223.

The uplink automatic gain controller 223 performs automatic gain control on the signal that has been received from the band pass filter 222.

The frequency converter 230 performs a frequency conversion on the signal, which has been received from the downlink automatic gain controller 223 of the uplink RF receiver 220, according to a predetermined format.

In order to offset the pilot signal that is used in the uplink RF unit 200, the second directional coupler 240 couples the signal received from the frequency converter 230 and the pilot signal received from the phase and level controller 520. At this time, the pilot signal is offset to prevent the pilot signal from being output through the uplink RF transmitter 250.

The uplink RF transmitter 250 increases the magnitude of the signal received from the second directional coupler 240 by a predetermined value to transmit the signal to the base station (not shown), and transmits the signal to the first switch 530.

The first switch 530 performs a function that switches the signal transmitted and received between the base station (not shown) and the first switch 530 through a donor antenna.

The second switch 540 performs a function that switches the signal that is transmitted and received between the mobile terminal (not shown) and the second switch 540 through a remote antenna.

The RF repeater can efficiently generate the transmission/reception synchronization signal of the RF repeater and a downlink automatic gain control signal to compensate for the downlink signal.

Further, the RF repeater maintains the received uplink signal at the predetermined level or more by using a pilot signal of a subcarrier, which is not allocated during the downlink period, regardless of the number of mobile terminals that are connected to the RF repeater. As a result, the RF repeater can perform automatic gain control on the uplink signal without performing separate signal analysis or control.

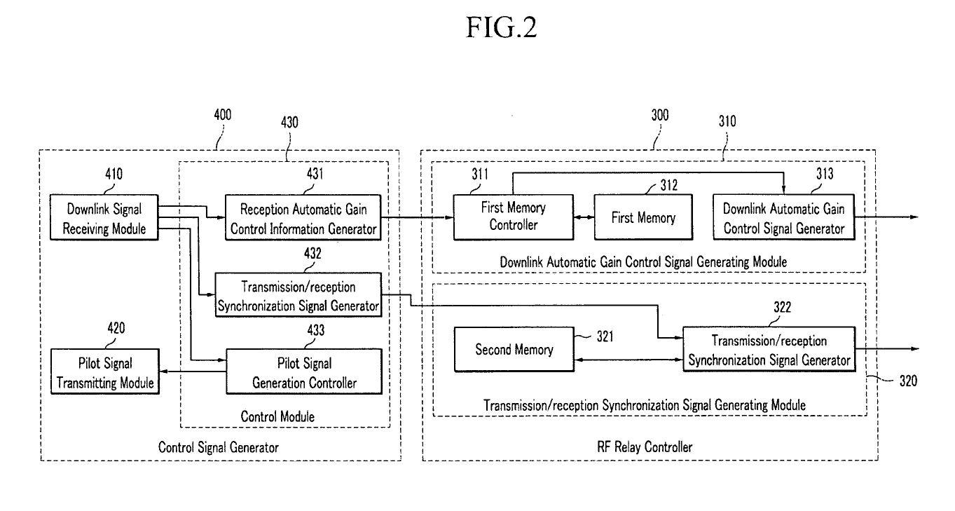

Next, a control signal generator and an RF delay controller of an RF repeater will be described in detail with reference to FIG. 2.

FIG. 2 is a block diagram specifically illustrating a control signal generator and an RF relay controller of an RF repeater according to an exemplary embodiment of the present invention.

As shown in FIG. 2, the control signal generator 400 according to the exemplary embodiment of the present invention includes the downlink signal receiving module 410, the pilot signal transmitting module 420, and the control module 430.

In this case, since the downlink signal receiving module 410 and the pilot signal transmitting module 420 have been described in detail with reference to FIG. 1, a repetitive description is omitted.

The control module 430 includes a reception automatic gain control information generator 431, a transmission/reception synchronization signal generator 432, and a pilot signal generation controller 433.

The reception automatic gain control information generator 431 converts the automatic gain performing signal, which has been received from the downlink signal receiving module 410, into automatic gain control information according to a predetermined conversion format. Then, the reception automatic gain control information generator 431 transmits the automatic gain control information to a downlink automatic gain control signal generator 313.

The transmission/reception synchronization signal generating module 432 transmits the synchronization signal that has been received from the downlink signal receiving module 410 to a transmission/reception synchronization signal generator 322 of the RF relay controller 300.

The pilot signal generation controller 433 receives the subcarrier information, which is allocated to the uplink during the next uplink period, from the downlink signal receiving module 410. The pilot signal generation controller 433 controls the pilot signal transmitting module 420 to generate the pilot signal of the subcarrier, which is not allocated during the next uplink period on the basis of the received subcarrier information.

The RF relay controller 300 includes the downlink automatic gain control signal generating module 310 and the transmission/reception synchronization signal generating module 320.

The downlink automatic gain control signal generating module 310 includes a first memory controller 311, a first memory 312, and the downlink automatic gain control signal generator 313.

The first memory controller 311 maps the automatic gain control information, which has been received from the reception automatic gain control information generator 431 of the control signal generator 400, with downlink gain variation control information, which has been stored in the first memory 312, and extracts gain information. The first memory controller 311 transmits the extracted gain information to the downlink automatic gain control signal generator 313.

In accordance with an automatic gain control operation of the control signal generator 400, the first memory 312 stores gain information calculated in advance to extract a gain obtained from the downlink signal.

The downlink automatic gain control signal generator 313 generates a downlink automatic gain control signal to perform gain control for a downlink signal on the basis of the gain information that has been received from the first memory controller 311. Then, the downlink automatic gain control signal generator 313 transmits the downlink automatic gain control signal to the downlink automatic gain controller 123 of the downlink RF receiver 120 shown in FIG. 1.

The transmission/reception synchronization signal generating module 320 includes the transmission/reception synchronization signal generator 322 and a second memory 321.

The transmission/reception synchronization signal generator 322 compensates for a path delay of a synchronization signal that has been received from the transmission/reception synchronization signal generator 432 of the control signal generator 400, on the basis of path delay compensation information that is stored in the second memory 321. The transmission/reception synchronization signal generator 322 generates a transmission/reception synchronization signal to synchronize the base station and the mobile terminal, and transmits the generated transmission/reception synchronization signal to the first switch 530 and the second switch 540.

The second memory 321 stores path delay compensation information according to a location of an RF repeater.

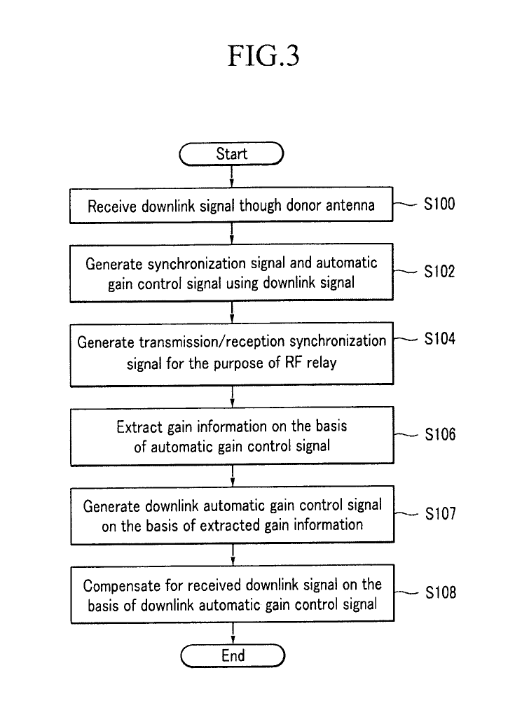

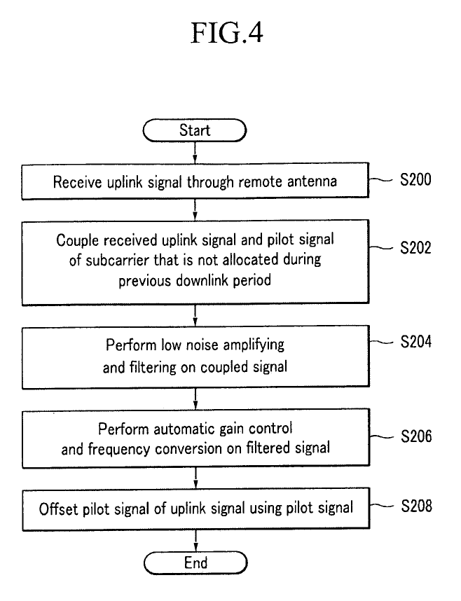

Next, an RF repeating method of an RF repeater according to the exemplary embodiment of the present invention will be described with reference to FIGS. 3 and 4.

FIG. 3 is a flowchart illustrating an RF repeating method of an RF repeater during a downlink period according to an exemplary embodiment of the present invention.

As shown in FIG. 3, according to the RF repeating method during a downlink period according to the exemplary embodiment of the present invention, the RF repeater receives a downlink signal that is to be transmitted from the base station (not shown) to the mobile terminal (not shown) through the donor antenna.

The RF repeater receives a downlink signal from the base station through the donor antenna (step S100), and generates a synchronization signal and an automatic gain control signal using the received downlink signal (step S102).

Then, the RF repeater generates a transmission/reception synchronization signal that compensates for a path delay of a synchronization signal generated by using the downlink signal according to the location of the RF repeater. The RF repeater then transmits a transmission/reception synchronization signal that is generated for the purpose of the RF relay between the mobile terminal (not shown) and the base station (not shown) to the base station and the mobile terminal (step S104).

Further, the RF repeater maps gain conversion information that is stored in advance on the basis of the generated automatic gain control signal and extracts the gain information (step S106). Then, the RF repeater generates a downlink automatic gain control signal to perform gain control of a downlink signal that is received on the basis of the extracted gain information (step S107).

The RF repeater compensates for the received downlink signal on the basis of the generated downlink automatic gain control signal (step S108).

Then, the RF repeater performs a frequency conversion on the compensated downlink signal according to a predetermined format, and transmits it to the mobile terminal (not shown) through the remote antenna.

FIG. 4 is a flowchart illustrating an RF repeating method of an RF repeater during an uplink period according to an exemplary embodiment of the present invention.

As shown in FIG. 4, according to the RF repeating method of the RF repeater during the uplink period according to the exemplary embodiment of the present invention, the RF repeater receives the uplink signal that is to be transmitted from the mobile terminal (not shown) to the base station (not shown) through the remote antenna.

The RF repeater receives the uplink signal from the mobile terminal (not shown) through the remote antenna (step S200), and couples the received uplink signal and a pilot signal of a subcarrier that is not allocated during a previous downlink period (step S202).

Then, the RF repeater performs a low noise amplifying operation on the coupled signal and performs a filtering operation to obtain a predetermined bandwidth (step S204). The RF repeater performs automatic gain control on the filtered signal.

Then, the RF repeater performs a frequency conversion on the signal on which the automatic gain control has been performed, according to a predetermined format (step S206). The RF repeater couples the pilot signal of the subcarrier, which is not allocated during the previous downlink period, and the phase converted pilot signal and the frequency converted signal, and offsets the pilot signal (step S208).

The RF repeater amplifies the signal, which is obtained by offsetting the pilot signal, by a predetermined value, and transmits the signal to the base station (not shown) through the donor antenna.

The exemplary embodiment of the present invention that has been described above may be implemented not only by a method and an apparatus but also by a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the structure of the RF repeater according to the exemplary embodiment of the present invention that has been described above, the RF repeater relays signal transmission and reception between the base station and the mobile terminal. The RF repeater can efficiently generate the transmission/reception synchronization signal and the automatic gain control signal to compensate for the downlink signal.

Further, the RF repeater maintains the received uplink signal at the predetermined level or more by using the pilot signal of the subcarrier, which is not allocated during the downlink period, regardless of the number of mobile terminals that are connected to the RF repeater. As a result, the RF repeater can efficiently perform automatic gain control on the uplink signal without separately performing signal analysis or control.

What is claimed is:

1. An RF repeater that relays signal transmission and reception between a base station and a mobile terminal, the RF repeater comprising:
a control signal generator that performs first automatic gain control on a downlink signal received from the base station and generates automatic gain control information that corresponds to the first automatic gain control;
a relay controller that extracts gain information corresponding to the automatic gain control information received from the control signal generator on the basis of gain variation information stored in advance, the gain variation information indicating the gain information on the automatic gain control information, and generates a control signal on the basis of the extracted gain information; and
a downlink RF unit that performs second automatic gain control on the downlink signal on the basis of the gain information, and performs a control operation such that the downlink signal on which the second automatic gain control has been performed is transmitted to the mobile terminal.

2. The RF repeater of claim 1, further comprising
an uplink RF unit that couples a pilot signal to an uplink signal received from the mobile terminal, performs third automatic gain control on a signal that is obtained by coupling the pilot signal and the uplink signal, removes the pilot signal from the signal on which the third automatic gain control has been performed, and transmits the signal to the base station,
wherein the control signal generator analyzes the downlink signal to extract information of a subcarrier allocated to an uplink, generates a pilot signal of information of a subcarrier that is not allocated, on the basis of the extracted information, and transmits the pilot signal to the uplink RF unit.

3. The RF repeater of claim 2, further comprising
a phase controller that receives the pilot signal, controls a phase of the pilot signal, and generates a first signal to offset the pilot signal,
wherein the uplink RF unit receives the first signal from the phase controller and removes the pilot signal from the signal on which the third automatic gain control has been performed.

4. The RF repeater of claim 3, wherein the downlink RF unit includes:
an amplifier that amplifies the downlink signal by a predetermined value;
a band pass filter that only filters a signal of a predetermined band with respect to the downlink signal amplified by the amplifier; and
an automatic gain controller that performs the second automatic gain control on the signal filtered by the band pass filter on the basis of the gain information.

5. The RF repeater of claim 1, wherein the control signal generator extracts a synchronization signal between the base station and the mobile terminal during a downlink period on the basis of the downlink signal.

6. The RF repeater of claim 5, wherein the relay controller receives the synchronization signal from the control signal generator, compensates for a path delay value for a location of the RF repeater that is stored in advance in the synchronization signal, and generates a transmission/reception synchronization signal to transmit/receive a signal between the base station and the mobile terminal.

7. An RF repeater that relays signal transmission and reception between a base station and a mobile terminal, the RF repeater comprising:
a control signal generator that analyzes a downlink signal to extract information of a subcarrier allocated to an uplink, and generates a pilot signal of information of a subcarrier that is which is not allocated, on the basis of the extracted information; and
an uplink RF unit that couples a pilot signal to an uplink signal received from the mobile terminal, performs automatic gain control on a signal that is generated by coupling the uplink signal and the pilot signal, removes the pilot signal from the signal on which the automatic gain control has been performed, and transmits the signal to the base station.

8. The RF repeater of claim 7, further comprising
a phase controller that receives the pilot signal from the control signal generator, controls a phase of the pilot signal, and generates a first signal to offset the pilot signal,
wherein the uplink RF unit receives the first signal from the phase controller and removes the pilot signal from the signal on which the automatic gain control has been performed.

9. The RF repeater of claim 8, wherein the uplink RF unit includes:
a first coupler that couples the uplink signal and the pilot signal;
an amplifier that amplifies the signal received from the first coupler by a predetermined value;
a band pass filter that only filters a signal of a predetermined band with respect to the signal that has been amplified by the amplifier;
an automatic gain controller that performs the automatic gain control on the signal received from the band pass filter;
a frequency converter that performs a frequency conversion on the signal received from the automatic gain controller according to a predetermined format; and
a second coupler that couples the signal received from the frequency converter and the first signal.

10. An RF repeating method in which an RF repeater relays signal transmission and reception between a base station and a mobile terminal, the method comprising:
receiving a downlink signal to be transmitted from the base station to the mobile terminal, and performing first automatic gain control on the downlink signal;
extracting gain information from the downlink signal on which the first automatic gain control has been performed, on the basis of gain variation information, the gain variation information indicating the gain information for the downlink signal;
performing second automatic gain control on the downlink signal on the basis of the extracted gain information; and
performing a control operation such that the downlink signal on which the second automatic gain control has been performed is transmitted to the mobile terminal.

11. The method of claim 10, further comprising, before the performing of the first automatic gain control:
extracting a synchronization signal between the base station and the mobile terminal on the basis of the downlink signal; and
compensating for a location compensation value of the RF repeater that is stored in advance in the synchronization signal, and generating a first synchronization signal to transmit/receive a signal between the base station and the mobile terminal.

12. An RF repeating method in which an RF repeater relays signal transmission and reception between a base station and a mobile terminal, the method comprising:
receiving an uplink signal from the mobile terminal;
coupling a first pilot signal that is not allocated during a downlink period before receiving the uplink signal to the uplink signal;
generating a second pilot signal to offset the first pilot signal;
performing automatic gain control on the downlink signal to which the first pilot signal is coupled; and
coupling the second pilot signal to the downlink signal to which the first pilot signal on which the automatic gain control has been performed is coupled.

13. The method of claim 12, wherein, in the generating of the second pilot signal, a phase of the first pilot signal is converted to offset the first pilot signal.

14. The method of claim 12, wherein the performing of the automatic gain control includes:
amplifying the downlink signal, to which the first pilot signal is coupled, by a predetermined value; and
filtering a signal of a predetermined band with respect to the downlink signal to which the amplified first pilot signal is coupled, and performing the automatic gain control on the filtered signal.
